(19) United States
(12) Patent Application Publication
(10) Pub. No.: US 2009/0055123 A1
(43) Pub. Date: Feb. 26, 2009

(54) DISTANCE BASED ASSOCIATION FOR ULTRA WIDE BAND (UWB) WIRELESS PERSONAL AREA NETWORK (PAN) DEVICES

(75) Inventor: Charles Razzell, Pleasanton, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/817,793

(22) PCT Filed: Mar. 2, 2006
(86) PCT No.: PCT/IB06/50664

§ 371 Date: Jun. 11, 2008

Related U.S. Application Data
(60) Provisional application No. 60/658,257, filed on Mar. 2, 2005.

(51) Int. Cl. G01S 3/02; G01B 21/02

(52) U.S. Cl. 702/159; 342/458

(57) ABSTRACT

Methods and wireless communication device for associating UWB (Ultra Wide Band) WPAN devices through the processing of ranging information. Ranging information represents the distance between a device and another device. Devices can automatically determine whether association has occurred via evaluation of, e.g., changes in distance, velocity and/or acceleration of devices, optionally in conjunction with a user-gated technique. The association between two wireless devices is carried out automatically when the distance between them is below a certain threshold. In a different embodiment, said distance information is used together with user-gated information to take a decision on associate or not associate two devices close to each other. Said user-gated information may be a confirmation given by the user to associate, e.g. through a button, etc.

The present invention relates generally to Personal Area Network (PAN) devices using Ultra Wideband (UWB) and, more particularly, to systems and methods used by these devices to associate with a Piconet Controller (PNC) using a ranging method, for example, a digital camera to a printer.

Technologies associated with the communication of information have evolved rapidly over the last several decades. For example, over the last two decades wireless communication technologies have transitioned from providing products that were originally viewed as novelty items to providing products which are the fundamental means for mobile communications. Perhaps the most influential of these wireless technologies were cellular telephone systems and products. Cellular technologies emerged to provide a mobile extension to existing wireline communication systems, providing users with ubiquitous coverage using traditional circuit-switched radio paths. More recently, however, wireless communication technologies have begun to replace wireline connections in almost every area of communications. Wireless local area networks (WLANs) are rapidly becoming a popular alternative to the conventional wired networks in homes, offices and public places (e.g., cafes, food chain restaurants, airports, aircrafts, etc.). Since the advent of UWB (Ultra Wideband), the opportunities for wireless communications in more areas of daily life are now expanded.

Wireless Personal Area Networks (WPANs) using UWB technology will provide high-speed digital connections between PCs and digital peripherals, such as flash memory cards and personal digital assistants (PDAs), or between printers and digital cameras. In order to initiate communication some form of association between the devices will first occur. In the case of wired connectivity, the devices that are to be associated with one another are physically plugged together with, for example, either a UWB or 1394 cable, and the correct association between devices is guaranteed. There is currently no simple equivalent to the wire and plug paradigm that can be employed for a wireless system. Since multiple, UWB capable devices may reside in, for example, the same room, it would be useful for the devices themselves to recognize when an association is intended.

Some solutions for providing associations in UWB WPAN devices have been contemplated, however these solutions involve at least some user interaction. One example involves providing each UWB device with a printed card having a serial number. This serial number is entered into a PC (for example) that the user wishes to be able to associate with the UWB device and then, when the UWB device gets in range of the PC, a YES/NO dialog box is displayed for confirmation of the association Some drawbacks to this solution are that the serial number may become lost, or it may become inconvenient for this dialog box to pop up each time that an allowed UWB device gets within range. Furthermore, portable devices may not have a suitable display to allow dialog box style interaction. A second technique involves providing both the PNC and UWB device with “associate now” buttons that are pressed simultaneously to establish an association. This solution suffers from the potential for accidental cross connections to occur in a densely populated area and from awkwardness in trying to get a user to simultaneously press two buttons on different devices. Yet another possible solution is to use an infra-red transmission to initiate the request for association and transfer other information as required. Some drawbacks to this solution are the extra expense of the IR transceivers, the need for a button to be pressed to initiate the IR association request, and the possibility that user intervention for admission of new devices might still be required.

Accordingly, it would be desirable to develop techniques and devices for UWB WPAN devices which overcome the aforementioned drawbacks.

### SUMMARY

Systems and methods according to the present invention address this need and others by providing techniques for association between wireless communication devices.

According to one exemplary embodiment of the invention, a method for associating wireless communication devices includes the step of transmitting and receiving a signal useable to obtain ranging information between two wireless communication devices. The ranging information is then used to automatically determine whether the wireless communication devices are associated with one another. This determination can be based, for example, on relative changes in position, measured velocity of one device during a measurement period and/or measured acceleration of one device during the measurement period.

According to another exemplary embodiment of the invention, a wireless communication device has a transceiver capable of transmitting and receiving a signal from which ranging information can be obtained, and a processor capable of processing the ranging information to determine whether an association has occurred between two wireless communication devices.

The accompanying drawings illustrate exemplary embodiments of the present invention, wherein:

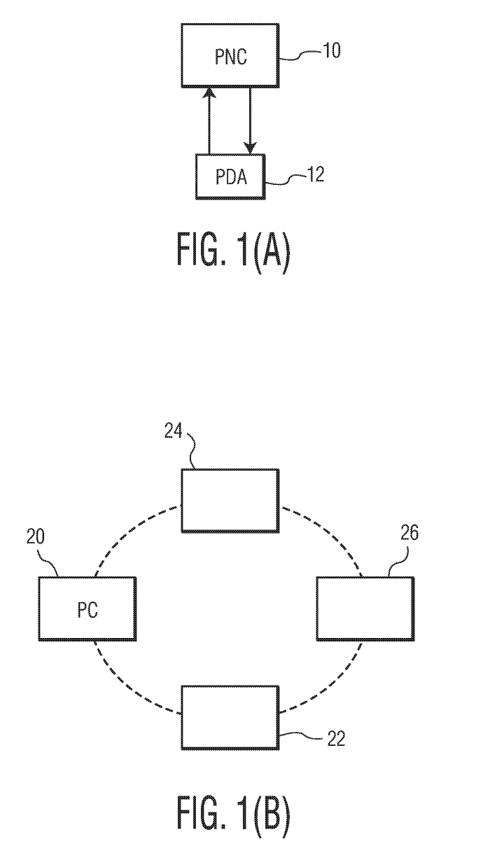

FIG. 1(a) illustrates a simple UWB WPAN communication loop between a PNC and a PDA.

FIG. 1(b) illustrates additional UWB WPAN devices communicating in a piconet.

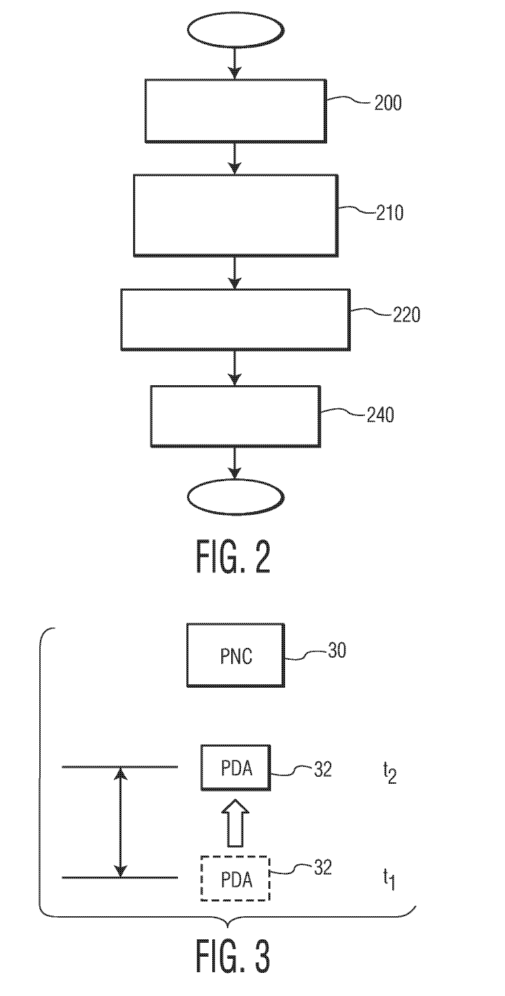

FIG. 2 depicts an exemplary method for two UWB devices to range one another.

FIG. 3 shows a gesture used to initiate association according to an exemplary embodiment of the present invention.

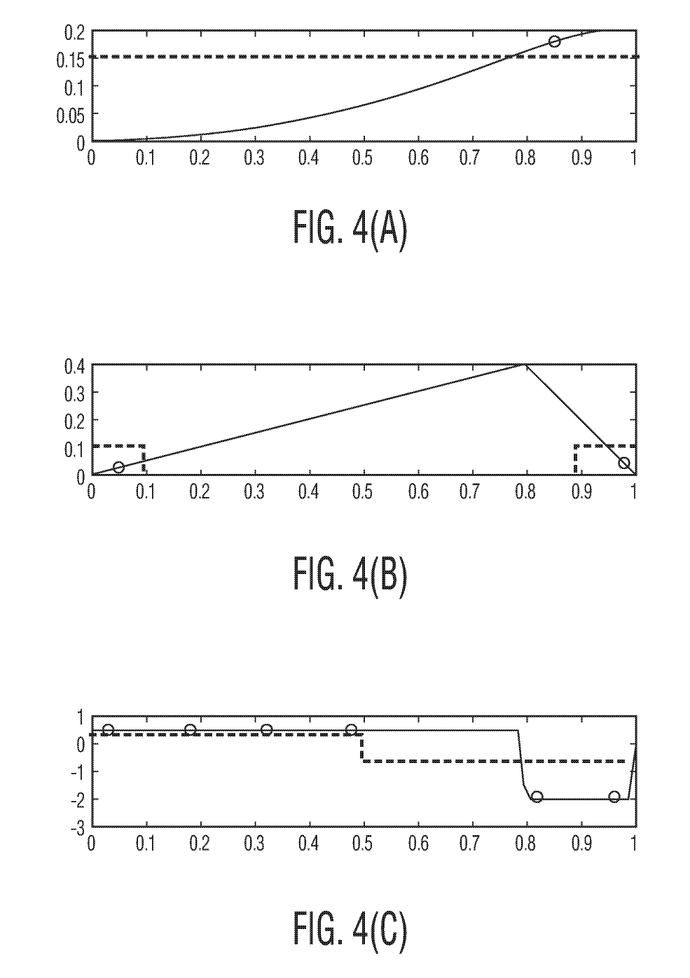

FIG. 4(a) illustrates association criteria based on distance versus time according to an exemplary embodiment of the present invention.

FIG. 4(b) illustrates association criteria based on speed versus time according to an exemplary embodiment of the present invention.

FIG. 4(c) illustrates association criteria based on acceleration versus time according to an exemplary embodiment of the present invention.

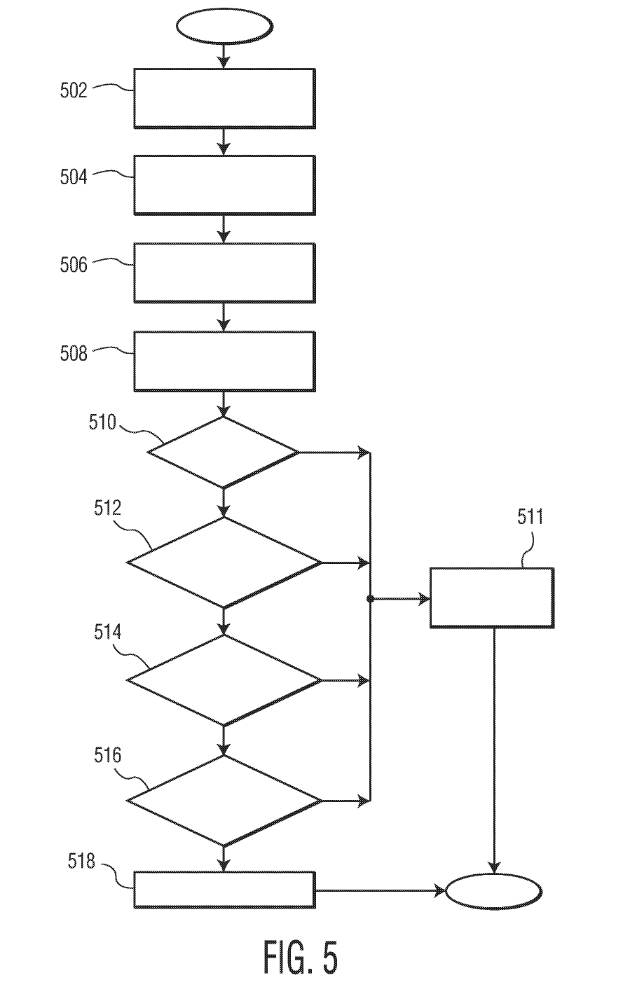

FIG. 5 depicts an exemplary method of UWB device association according to an exemplary embodiment of the present invention.

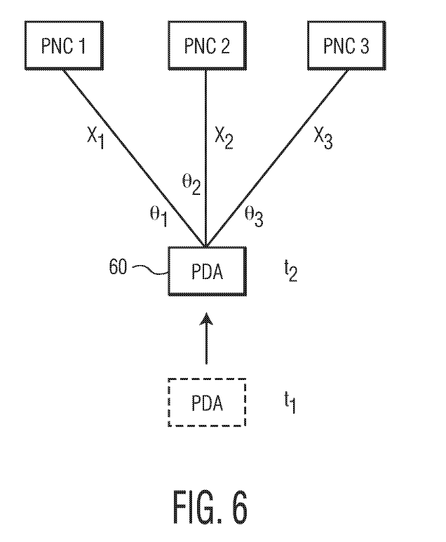

FIG. 6 shows how a UWB device discriminates between PNCs according to an exemplary embodiment of the present invention.

The following detailed description of the invention refers to the accompanying drawings. The same reference numbers in different drawings identify the same or similar elements. Also, the following detailed description does not limit the invention. Instead, the scope of the invention is defined by the appended claims.

In order to provide some context for this description, exemplary UWB WPAN systems in which exemplary embodiments of the present invention can be implemented will now be described with respect to FIG. 1(a) and FIG. 1(b). FIG. 1(a) shows a UWB WPAN of just two devices, i.e., a PNC 10 and another UWB device 12, such as a PDA. The UWB devices each include a transceiver and processor, e.g., the transceiver 14 and processor 16 of PDA device 12, for wirelessly communicating with one another and processing information as described below. FIG. 1(b) shows a UWB WPAN consisting of multiple devices in a piconet which communicate with each other, such as a PC 20, a printer 22, a cell phone 24, and a digital camera 26. These devices communicate using UWB communication techniques, however the present invention is not limited to wireless communication devices which use UWB techniques. As will be appreciated by those skilled in the art, UWB communication techniques provide for high data rate and low power output communications, using a variety of modulation techniques over a very large bandwidth. More details regarding UWB communication techniques are available in the draft specification from IEEE task group 802.15.3a.

One aspect of UWB devices of interest for this specification is their capability to implement ranging functions due to the very large bandwidth associated with the signals that they transmit. It is anticipated that these ranging functions will be able to provide ranging information which identifies a distance between, e.g. PNC 10 and PDA 12, to within a predetermined precision, e.g. 10 cm. This ranging information can be used according to exemplary embodiments of the present invention to provide an automated association between UWB devices.

An exemplary ranging function which can be implemented between the UWB devices of FIG. 1(a), will now be described with respect to the flowchart of FIG. 2. According to exemplary embodiments of the present invention, a two-way time transfer (TWTT) technique can be used to perform ranging between any two UWB devices. Two messages (A and B) are exchanged between the devices 10 and 12 at step 200. The two messages can be transmitted simultaneously by the two devices or one message can be transmitted first and the second message transmitted by the second UWB device upon receipt of the first message. In either case, the transmission time (Ta and Tb) and the reception time (Ra and Rb) of both messages are recorded at step 210. The two UWB devices 10 and 12 will be separated by an unknown distance (unknown propagation delay, tpropagation) and will have an unknown offset between their internal clocks (toffset). These two unknowns can be solved for by setting up two simultaneous equations in two unknowns as:

Ra=Ta+toffset+tpropagation (1)

Rb=Tb−toffset+tpropagation (2)

and then solving for toffset and tpropagation at step 220. The range between the devices 10 and 12 can then be determined directly from the propagation delay and the known speed of the transmissions at step 240. It will be appreciated that the foregoing is simply an example of one ranging technique which can be used in techniques according to the present invention and that other ranging techniques may be substituted therefor.

According to exemplary embodiments of the present invention, the ranging information obtained using, for example, the techniques described above, can be used to automatically determine if UWB devices become associated (or disassociated) with one another. Changes in relative positions between two UWB devices can be, for example, detected and compared to predetermined conditions to determine if an association (or disassociation) occurs. FIG. 3 shows an example of two UWB devices which a user intends to associate with one another. Therein, one UWB device 30 is stationary and the other UWB device 32 is moved by a user to close the distance between the two UWB devices. From positional data obtained during a measurement period, this movement can be identified as an association gesture. Note, however, that the present invention is not to be considered limited to embodiments where one device is stationary and one device is mobile. The present invention includes motion by either or both devices, as well as applications where multiple devices are associating with one another.

According to an exemplary embodiment of the present invention, association can be determined through various types of positional data. The associating gesture described above (or other gestures) can be defined by certain parameters which can, in turn, be derived from ranging information. For example one or more of: (1) distance between the devices at time t1 (start of measurement time) and time t2 (end of measurement time), (2) speed of device movement at time t1 and time t2, and (3) acceleration of the device at time t1 and time t2, can be used to define and identify the occurrence of an associating gesture. FIG. 4(a) illustrates an exemplary distance parameter. For example, if the distance between devices 30 and 32 closes by more than a predetermined amount (e.g., 15 cm) during the measurement period (e.g., one second), then the movement can be identified as an associating gesture. Similarly, if the velocity is near zero, increases, then returns to zero during the measurement period, then this may also be identified as indicative of an associating gesture as shown in FIG. 4(b). Likewise, for an associating gesture involving a user “poking” a portable UWB device toward another UWB device, the acceleration should first be positive, and then negative for some portion of the measurement period. Thresholds also can be applied to the velocity and/or acceleration tests. The tests can be used individually, alternatively (logical OR) or together (logical AND). Thus, according to one exemplary embodiment of the present invention, an association will be identified by device 30 or 32 as occurring when (a) the distance between the two devices decreases by a predetermined amount during the measurement period, (b) the velocity goes from zero to a positive velocity and back to zero during the measurement period, and (c) the acceleration is first positive and then negative during the measurement period.

According to an exemplary embodiment of the present invention, a method for associating devices using the above-described associating gesture operates as illustrated in the flowchart of FIG. 5. Relative positional information is determined between UWB device 30 and UWB device 32 at time t1 (step 502). A closing gesture occurs, moving one UWB device closer to another UWB device (step 504). Ranging information is gathered on an ongoing basis between devices 30 and 32. At time t2, the measurement period ends (step 506). At this point all of the relative positional information gathered between time t1 and time t2 is processed (step 508) to determine if association between the devices occurred during the measurement period. In this example, an absolute distance threshold is first employed so that only gestures performed proximate another device are identified as associating gestures, i.e., only devices which are physically close together can become associated with one another even if a more distant device could detect the associating gesture. Thus, if the UWB devices are within a specified minimum distance (e.g., one meter) then association is permitted at step 510, if not then association does not occur (step 511). If the change in relative distance between the UWB devices exceeds the minimum threshold during the measurement period then association could occur, if not then association does not occur (step 512). If the gesturing device is at the correct speed at time t1 and time t2 then association could occur, if not then association does not occur (step 514). If the gesturing device shows the correct acceleration characteristics during the time period from time t1 to time t2 then association could occur, if not then association does not occur (step 516). If all four positional conditions were met during the processing illustrated in FIG. 5 then association occurs (step 518).

According to an exemplary embodiment of the current invention, the foregoing embodiments can be combined with other tests, e.g., the aforedescribed user-gated techniques. For example, these ranging association techniques can be used in conjunction with one or more of: (1) providing each UWB device with a printed card having a serial number. This serial number is entered into a PC (for example) that the user wishes to be able to associate with the UWB device and then, when the UWB device gets in range of the PC, a YES/NO dialog box is displayed for confirmation of the association; (2) providing both the PNC and UWB device with “associate now” buttons that are pressed simultaneously to establish an association; (3) to use an intra-red transmission to initiate the request for association and transfer other information as required; (4) other user-gated authorization techniques. According to an exemplary embodiment of the current invention, any or all of the above user-gated authorization techniques could be used in conjunction with any of the ranging information described above to provide a robust technique for ensuring that a device is allowed to associate when a new device is detected by the PNC.

UWB devices that have become associated with one another will have the ability to leave the piconet or disassociate. According to an exemplary embodiment of the current invention, disassociation between UWB devices, for example device 30 and device 32, occurs when the predetermined action(s) related to association is repeated, when an action that is the reverse of the associating gesture occurs, or based on a condition that is not either of the above, for example, powering off a UWB device.

In some environments, an associating gesture may be performed by a user with a handheld UWB proximate a number of candidates for association. One way to determine the device with which the user wishes to establish an association is to use previous association data, e.g., to assume that the user wants to associate with the same device with which a previous association was established. Of course, the same handheld device may have previously been associated with a number of nearby devices. Thus, according to another exemplary embodiment of the present invention, using the relative positional data previously acquired via the ranging techniques, a voting procedure among PNCs could be used, whereby, the PNC with which the user's device experiences the largest relative amplitude change for one or more of distance, speed, and acceleration is the device that is identified for association. This operates relative to the user's device 60 on the principle that a scaling factor cos applies to these measurements, when observed by a PNC at an angle of to the axis of the pointing gesture. This can be seen in FIG. 6, wherein the relative angles of 1, 2, 3 will affect the relative measurements associated with changes in distance, velocity and/or acceleration relative to PNC 1, PNC 2 and PNC 3.

According to another exemplary embodiment of the current invention, when a UWB device becomes associated or disassociated from another UWB device user feedback is provided. This user feedback, for example, could be in the form of a synthesized sound similar to the click of a mechanical plug being inserted and could be generated from either or both UWB devices. Other sounds or forms of media, such as a light, could be used to provide user feedback on association or disassociation of UWB devices.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A wireless communication device comprising:
a transceiver capable of transmitting and receiving a signal useable to obtain ranging information between said transceiver and another device; and
a processor capable of processing said ranging information to
automatically determine whether said wireless communication device has become associated with said another device.

2. The device of claim 1, wherein said transceiver and said processor operate to obtain said ranging information by: (a) exchanging ranging messages between said transceiver and said another device, (b) solving for a propagation delay between said transceiver and said another device based upon transmission times and reception times of said ranging messages and (c) determining said ranging information based on said propagation delay.

3. The device of claim 1, wherein the ranging information is a distance between said transceiver and said other device.

4. The device of claim 1, wherein said processor determines that said device is associated with said another device when at least one first condition occurs based on said ranging information obtained during a measurement period.

5. The device of claim 4, wherein said at least one condition is that a distance, between said devices, has closed by a predetermined amount during the measurement period.

6. The device of claim 4, wherein said at least one condition is that a velocity, between said devices, goes from zero to a positive value and then back to zero during the measurement period.

7. The device of claim 4, wherein said at least one condition is that an acceleration, between said devices, is first positive and then negative during the measurement period.

8. The device of claim 1, wherein user feedback is provided when said processor determines that said wireless communication devices has become associated with said another device.

9. The device of claim 8, wherein user feedback is also provided upon disassociation.

10. The device of claim 4, wherein said processor subsequently determines that said wireless communication device has become disassociated with said another device based upon at least one disassociation condition, which is different than said at least one condition that said processor uses to determine association.

11. A method for wireless communication comprising the steps of:
transmitting and receiving a signal useable to obtain ranging information between said wireless communication device and another device; and processing said ranging information to automatically determine whether said wireless communication device has become associated with said another device.

12. The method of claim 11, wherein said step of obtaining ranging information further comprises the steps of: (a) exchanging ranging messages between said transceiver and said another device, (b) solving for a propagation delay between said transceiver and said another device based upon transmission times and reception times of said ranging messages and (c) determining said ranging information based on said propagation delay.

13. The method of claim 11, wherein the ranging information is a distance between said transceiver and said other device.

14. The method of claim 11, wherein said processor determines that said device is associated with said another device when at least one first condition occurs based on said ranging information obtained during a measurement period.

15. The method of claim 14, wherein said at least one condition is that a distance, between said devices, has closed by a predetermined amount during the measurement period.

16. The method of claim 14, wherein said at least one condition is that a velocity, between said devices, goes from zero to a positive value and then back to zero during the measurement period.

17. The method of claim 14, wherein said at least one condition is that an acceleration, between said devices, is first positive and then negative during the measurement period.

18. The method of claim 11, further comprising the step of: providing user feedback when said processor determines that said wireless communication devices has become associated with said another device.

19. The method of claim 18, wherein the step of providing user feedback further comprises the step of: providing said user feedback upon disassociation.

20. The method of claim 14, wherein said processor subsequently determines that said wireless communication device has become disassociated with said another device based upon at least one disassociation condition, which is association.

21. A wireless communication device comprising:
a transceiver capable of transmitting and receiving a signal useable to obtain ranging information between said transceiver and another device; and
a processor capable of processing said ranging information together with at least one user-gated authorization technique to determine whether said wireless communication device has become associated with said another device.

22. The wireless communication device of claim 1, wherein said a processor automatically determines that said wireless communication device has become associated with said another device when said wireless communication device is within one foot of said another device.

23. The wireless communication device of claim 22, wherein said processor automatically determines that said wireless communication device has become associated with said another device when said wireless communication device is within 30 cm of said another device.

24. The method of claim 11 further comprising the step of: automatically determining that said wireless communication device has become associated with said another device when said wireless communication device is within one foot of said another device.

25. The method of claim 24, further comprising the step of: automatically determining that said wireless communication device has become associated with said another device when said wireless communication device is within 30 cm of said another device.
